(19) United States
(12) Patent Application Publication
(10) Pub. No.: US 2025/0276706 A1
(43) Pub. Date: Sep. 4, 2025

(54) ARTIFICIAL INTELLIGENCE-BASED VEHICLE SOFTWARE MANAGEMENT

(71) Applicant: Toyota Motor North America, Inc., Plano, TX (US)

(72) Inventors: Simon P. ROBERTS, Celina, TX (US); Dineth KUMARASINGHE, Flower Mound, TX (US); William HARGIS, Celina, TX (US); David TSAI, Irvine, CA (US); Shravanthi DENTHUMDAS, Frisco, TX (US); Brian KURSAR, Fairview, TX (US)

(73) Assignees: Toyota Motor North America, Inc., Plano, TX (US); Toyota Jidosha Kabushiki Kaisha, Toyota-shi, Aichi-ken (JP)

(21) Appl. No.: 18/591,987

(22) Filed: Feb. 29, 2024

(51) Int. Cl. B60W 50/02; G06F 8/65

(52) U.S. Cl. CPC B60W 50/0225; B60W 50/0205; G06F 8/65

(57) ABSTRACT

Aspects of the present disclosure provide techniques for artificial intelligence based vehicle software management. An example method includes detecting a defect in first code associated with one or more computing devices of a vehicle. The method further includes generating a correction to the defect using a first artificial intelligence (AI) model. The method further includes obtaining updated code of the first code based at least in part on the correction. The method further includes determining that the updated code satisfies one or more criteria. The method further includes transferring the updated code to the vehicle in response to the updated code satisfying the one or more criteria.

### TECHNICAL FIELD

The present disclosure generally relates to software development, and more particularly, to vehicle software management.

### BACKGROUND

Vehicles are becoming increasingly computerized. A modern day vehicle is often equipped with dozens of computers and electronic devices to enable various features, such as infotainment, safety systems, navigation, and autonomous driving. Safety systems help minimize the chances of an accident or reduce the effects of a collision to occupants of a vehicle. For example, safety systems may include airbag systems, antilock brake systems, a rearview camera, etc. In some cases, the safety systems may include advanced driver-assistance systems (ADAS), such as collision avoidance, lane departure warning, adaptive cruise control, and the like. ADAS can enable various degrees of autonomous driving. A navigation system allows a driver to enter a destination and provides a series of driving instructions (e.g., a route) to help the driver reach the destination. Infotainment is a system that combines entertainment such as radio and music playing with driving information, including navigation, ADAS, and vehicle settings. Some infotainment systems employ a high-resolution touchscreen and/or a digital instrument cluster as interfaces.

### SUMMARY

Some aspects provide a method. The method includes detecting a defect in first code associated with one or more computing devices of a vehicle. The method further includes generating a correction to the defect using a first artificial intelligence (AI) model. The method further includes obtaining updated code of the first code based at least in part on the correction. The method further includes determining that the updated code satisfies one or more criteria. The method further includes transferring the updated code to the vehicle in response to the updated code satisfying the one or more criteria.

Some aspects provide a system. The system includes one or more memories and one or more processors coupled to the one or more memories. The one or more processors are configured to cause the system to detect a defect in first code associated with one or more computing devices of a vehicle; generate a correction to the defect using a first artificial intelligence (AI) model; obtain updated code of the first code based at least in part on the correction; determine that the updated code satisfies one or more criteria; and transfer the updated code to the vehicle in response to the updated code satisfying the one or more criteria.

Some aspects provide a system. The system includes means for detecting a defect in first code associated with one or more computing devices of a vehicle. The system further includes means for generating a correction to the defect using a first artificial intelligence (AI) model. The system further includes means for obtaining updated code of the first code based at least in part on the correction. The system further includes means for determining that the updated code satisfies one or more criteria. The system further includes means for transferring the updated code to the vehicle in response to the updated code satisfying the one or more criteria.

Some aspects provide a non-transitory processor-readable medium. The processor-readable medium has instructions stored thereon for performing a method. The method includes detecting a defect in first code associated with one or more computing devices of a vehicle. The method further includes generating a correction to the defect using a first artificial intelligence (AI) model. The method further includes obtaining updated code of the first code based at least in part on the correction. The method further includes determining that the updated code satisfies one or more criteria. The method further includes transferring the updated code to the vehicle in response to the updated code satisfying the one or more criteria.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an example for artificial intelligence (AI)-based vehicle software management;

FIG. 2 depicts an example architecture for AI-based vehicle software management;

FIG. 3 depicts an example an example neural network for software application generation;

FIG. 4 depicts an example an example architecture for training one or more AI models to correct defective code;

FIG. 5 depicts example operations of AI-based vehicle software management;

FIG. 6 depicts an example of a processing system that is configured to perform the operations described herein; and

FIG. 9 depicts an example processing system.

### DETAILED DESCRIPTION

Aspects of the present disclosure provide systems, methods, and computer-readable mediums for artificial intelligence (AI) based vehicle software management.

A modern day vehicle employs a network of computing devices to provide various features, such as infotainment, powertrain controls, safety systems, navigation, autonomous driving, wireless connectivity, etc. Each of these computing devices executes software to facilitate these features. In some cases, a single vehicle may have 70 to 100 electronic control units (ECUs) interconnected and running hundreds of millions lines of code. This software may be maintained at least in part by a vehicle manufacturer, which may be responsible for maintaining the software of multiple makes and generations of vehicles. When a bug or defect is found in the code, a team of software developers may be tasked with developing a fix to the bug, reviewing the fix, testing the fix, and deploying the fix to the codebase. Thus, a vehicle manufacturer may expend non-trivial amounts of time and resources in maintaining the software of a vehicle, and especially across multiple product lines and brands of vehicles.

Aspects of the present disclosure provide techniques for AI-based vehicle software management. In certain aspects, an AI system may generate new code to repair or heal defects in existing code as supplemental code and/or replacement code for software updates (e.g., over-the-air (OTA) updates) to certain computing devices of vehicles, including cars and/or trucks. As an example, a generative AI system may detect code defects for embedded computing devices of vehicles, develop code fixes, test the code fixes, and deploy the code fixes to the computing devices of vehicles, for example, the vehicles associated with a model and model year. Examples of the embedded computing devices in vehicles may include microcontroller units (MCUs), electronic control units (ECUs), an advanced driver-assistance system (ADAS), an infotainment system, instrument cluster, etc.

The system may include a defect detection system and a defect correction system. The defect detection system and/or defect correction system may be trained to inspect and/or fix software defects associated with computing devices including vehicle-based computing devices. In some cases, a generative AI system may inspect and solve software defects of embedded devices on vehicles continuously and further be trained and updated through the process. In certain cases, the trained models may be collected and used for future uses in different vehicles with a similar software and/or hardware architecture.

The techniques for AI-based vehicle software management described herein may provide any of various advantages and/or beneficial effects. The techniques for AI-based vehicle software management described herein enable improved performance of software management. The techniques for AI-based vehicle software management may enable reduced resources in developing and deploying fixes to a vehicle codebase, for example, in terms of time and personnel. The techniques for AI-based vehicle software management may enable the management of complex vehicle systems that use hundreds of millions lines of code, for various features, such as ADAS.

### Example AI-based Vehicle Software Management System

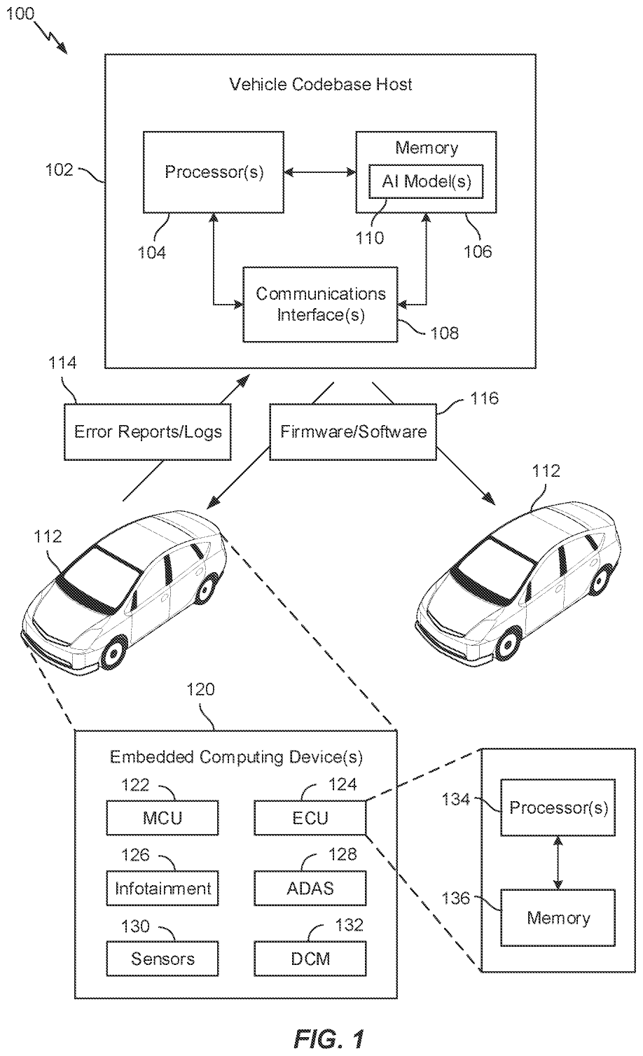

FIG. 1 depicts an example system 100 for AI-based vehicle software management. In this example, the system 100 includes a vehicle codebase host 102. The vehicle codebase host 102 may include one or more processors 104 (hereinafter “the processor 104”), one or more memories 106 (hereinafter “the memory 106”), and one or more communications interfaces 108 (hereinafter “the communications interface 108”). The processor 104 may be coupled to the memory 106 and the communications interface 108. In some cases, the memory 106 may be coupled to the communications interface 108.

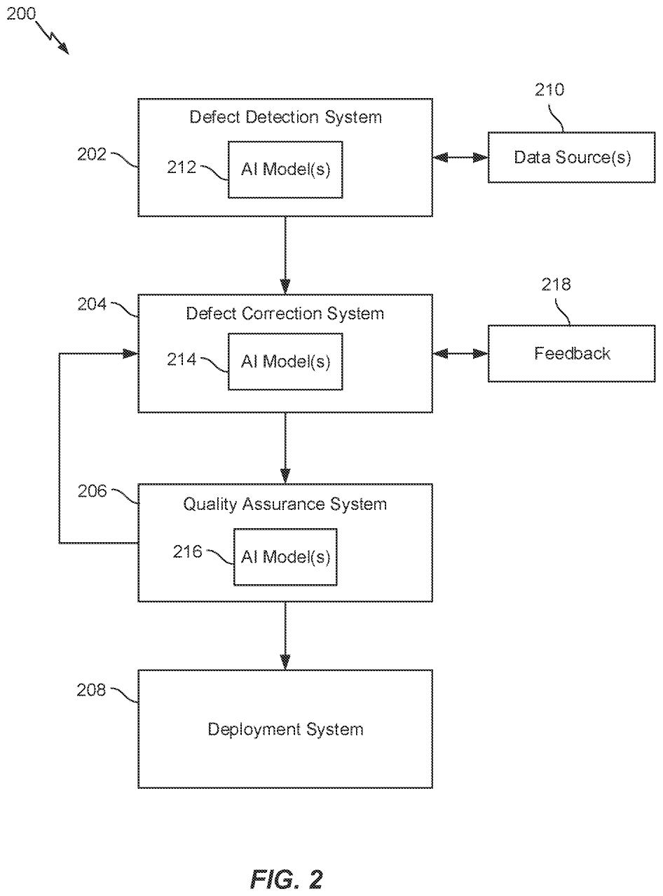

The processor 104 may be or include any device capable of executing processor-readable instructions stored in the memory 106. As an example, the processor(s) 104 may be or include one or more of: a microcontroller, a microprocessor, an AI processor, a digital signal processor (DSP), a central processing unit (CPU), a graphics processing unit (GPU), a field programmable gate array (FPGA), a programmable logic device (PLD), a computer, or any other suitable computing device. The processor 104 may be configured to implement one or more AI models 110 (hereinafter “the AI model 110”), for example, as further described herein with respect to FIG. 2. In certain aspects, the processor 104 may perform the techniques for AI-based vehicle software management described herein.

The memory 106 may be include one or more non-transitory computer readable media. As an example, the memory 106 may be or include one or more of: random access memory (RAM), read-only memory (ROM), flash memory, a hard drive, or any non-transitory memory device capable of storing processor-executable instructions such that the instructions can be accessed and executed by the processor 104. The functionality described herein may be implemented in any computer programming language or object code, as pre-programmed hardware elements, or as a combination of hardware and software components.

The communications interface 108 may be configured to facilitate communications with one or more other devices, such as one or more vehicles 112 (hereinafter “the vehicle 112”). As shown, the vehicle codebase host 102 is in communication with the vehicle 112. In some cases, the communications interface 108 may be or include a network interface controller (e.g., an Ethernet controller, fiber optic transceiver, controller area network (CAN bus), etc.) and/or a wireless communications interface (e.g., a radio frequency transceiver) configured to communicate with one or more other devices, for example, in a data network. As an example, the data network may include a private data network, a public data network (e.g., the internet), or a hybrid data network. In certain cases, the communications interface 108 may be or include an input/output interface (e.g., a universal serial bus, inter-integrated circuit (I2C), etc.) for communicating with auxiliary or external hardware, such as embedded computing devices.

In certain aspects, the vehicle codebase host 102 may receive an indication of defective code (e.g., software or firmware), which is stored and executable on or at the vehicle 112. The vehicle codebase host 102 may receive the indication from the vehicle 112, an issue tracking system, and/or an internal defect detection system, as further described herein with respect to FIG. 2. As an example, the vehicle codebase host 102 may receive one or more error reports or logs (hereinafter “the error report 114”) from the vehicle 112. The error report 114 may indicate that one or more defects are in code (e.g., software or firmware) being used at the vehicle 112. The error report 114 may be or include an indication of where the error occurred in the source code (e.g., as an error identifier) and/or one or more logs generated by the code.

Based on the error report 114, the vehicle codebase host 102 generates a fix to the defective code using the AI model 110, as further described herein with respect to FIG. 2. The vehicle codebase host 102 may merge the fix with a codebase (e.g., source code) to generate updated code 116 (e.g., updated software or firmware). The vehicle codebase host 102 may send the updated code 116 to the vehicle 112. The updated code 116 may include one or more executable package of software or firmware. In some cases, the vehicle codebase host 102 may store the code 116 and/or information that can enable reproduction of the code 116 (e.g., source code) in the memory 106. The code 116 may be stored in the memory 106 to enable delayed deployment of the code 116, distribution of the code 116 to multiple devices, and/or editing of the code via feedback, for example.

The vehicle 112 may send the error report 114 to the vehicle codebase host 102 through a data network, such as the internet, interconnecting the vehicle codebase host 102 and the vehicle 112. In some cases, the vehicle 112 may send the error report 114 to the vehicle codebase host 102 via a wired interface, for example, on-board diagnostics, Ethernet, CAN, USB, I2C, etc. In certain cases, the vehicle 112 may send the error report 114 to the vehicle codebase host 102 via a wireless communication channel of a radio access technology, such as wireless local area network (WLAN), wireless wide area network (WWAN), Bluetooth, etc.

The vehicle 112 may include one or more computing devices 120, which may run software and/or firmware that is managed by the vehicle codebase host 102. As an example, the computing devices 120 may be or include one or more of: one or more micro-controller units (MCUs) 122, one or more electronic control units (ECUs) 124, an infotainment system 126, one or more ADAS 128, one or more sensors 130, or one or more data communication modules (DCM) 132. Note that other types of computing devices may be employed at a vehicle in addition to or instead of those depicted in FIG. 1. The MCU 122 may be or include a microcontroller responsible for controlling one or more vehicle systems or functions. The ECU 124 may be or include a computer responsible for controlling one or more vehicle systems or functions.

The infotainment system 126 may be or include a computing device configured to allow a user (e.g., the driver and/or passenger) to access and control various functions of one or more vehicle components of the vehicle and/or monitor vehicle components in real-time.

The ADAS 128 may be or include a computing device configured to implement any of various operations that assist a driver with safe operation of the vehicle 112. The ADAS 128 may automate lighting, provide adaptive cruise control, assist in avoiding collisions, incorporate satellite navigation and traffic warnings, alert drivers to possible obstacles, assist in lane departure and lane centering, provide navigational assistance through smartphones, and provide any suitable other safety features for vehicle operations.

Various examples of different types of sensors will be described herein. The sensors 130 may be or include, for example, one or more vehicle sensors, a radio frequency sensor (e.g., a radar sensor), an acoustic sensor (e.g., a microphone or a sonar sensor), and/or an optical sensor (e.g., a lidar sensor). Note that the aspects of the present disclosure are not limited to the particular sensors described. The sensors 130 can include one or more vehicle sensors. The vehicle sensor(s) can detect, determine, and/or sense information about the vehicle 112 itself. In certain aspects, the vehicle sensor(s) can be configured to detect, and/or sense position and orientation changes of the vehicle, such as, for example, based on inertial acceleration. The vehicle sensor(s) can include an emissions sensor, pressure sensor, temperature sensor, mass (air) flow sensor, ADAS sensor, one or more accelerometers, one or more gyroscopes, an inertial measurement unit (IMU), a dead-reckoning system, a global navigation satellite system (GNSS), a global positioning system (GPS), a navigation system, and/or any other suitable sensor.

In certain aspects, a computing device (e.g., the ECU 124) may include one or more processors 134 (hereinafter “the processor 134”) and one or more memories 136 (hereinafter “the memory 136”) coupled to the processor 134. The processor 104 and the memory 106 may be representative of the processor 134 and the memory 136, respectively. In some cases, a computing device may be or include a server, a computer, a virtual computing device, or any other electronic device or computing system capable of running the code 116 as described herein. The processor 118 may run the code 116, which may be stored in the memory 136. The code 116 may be or include one or more instructions that, when executed by the processor 134, cause the vehicle 112 to perform one or more actions. For example, the code 116 may include instructions for controlling or performing certain vehicle functions (e.g., powertrain controls, braking controls, steering controls, etc.), ADAS functions, infotainment functions, navigation functions, communication functions, etc.

In certain aspects, the vehicle codebase host 102 may be integrated with the vehicle 112. For example, the vehicle 112 may perform the AI-based software management described herein using at least the processor 134 and the memory 136.

FIG. 2 depicts an example architecture 200 for AI-based vehicle software management. In this example, the architecture 200 comprises a defect detection system 202, a defection correction system 204, a quality assurance (QA) system 206, and a deployment system 208. In certain aspects, the architecture 200 may be implemented by a processing system, such as the vehicle codebase host 102 of FIG. 1.

The defect detection system 202 is configured to detect a defect in code that runs in or at a vehicle, for example, as described herein with respect to FIG. 1. The defect correction system 202 may employ code analysis techniques to identify defects in the existing code in embedded devices, such as bug pattern matching, data flow analysis, or test case generation to identify areas of the code that can benefit from improvement or fixing. The defect detection system 202 may be trained with both correct code and instances with known defects with a wide range of defects and their corresponding fixes. The defect detection system 202 may be continuously trained by self-generated corrections or defective code samples. The defect detection system 202 may label and represent the defects in a code for fixing. The defect detection system 202 may correlate between the defects and their corresponding fixed code snippets. The defect detection system 202 may be trained to learn the mapping between code snippets with defects and their corresponding fixed code snippets.

In certain aspects, the defect detection system 202 is in communication with one or more data sources 210 (hereinafter “the data source 210”). The data source 210 may be or include a source of information on code that is or expected to be stored and executable at or on a vehicle (e.g., the vehicle 112). The data source 210 may be or include one or more vehicles (e.g., the vehicle 112), a source code repository, and/or an issue tracking system for the vehicle codebase. The defect detection system 202 may inspect or monitor the data source 210 for defective code in the vehicle codebase. The defect detection system 202 may obtain, from the data source 210, an indication that a defect is in the codebase of the vehicle. The indication may be or include a report, log, or an issue posted to the issue tracking system. The defect detection system 202 may inspect the source code of software and/or firmware used at or in or a vehicle. The defect detection system 202 may periodically inspect the source code. The defection detection system 202 may inspect the source code in response to certain events, such as a request to update a vehicle codebase (e.g., a base branch), a merger of updated code with the vehicle codebase (e.g., the base branch), etc. The defect detection system 202 may use one or more AI models 212 (hereinafter “the AI model 212”) to detect a defect in source code. The AI model 212 may obtain input data, which may include the source code of the vehicle codebase; and the AI model 212 may provide output data, which may include a prediction or an indication that a defect is in the vehicle codebase. The defect detection system 202 sends the defective code to the defect correction system 204. In some cases, the defect detection system 202 may classify the code defect and notify the defect correction system 204 of the classification.

The defect correction system 204 may be configured to correct the defect detected in the vehicle codebase. The defect correction system 204 may use trained generative AI models to generate candidate fixes for the identified defects. The defect detection system 202 may feed the defective code as input to the defect correction system 204, which may generate potential fixes based on learned patterns and/or structures from training data. The defect correction system 204 may generate code snippets that address the specific defect types observed in the input code. The defect correction system 204 may use one or more AI models 214 (hereinafter “the AI model 214”) to generate a correction to defective code. The AI model 214 may obtain input data, which may include the defective code (e.g., the corresponding source code); and the AI model 214 may provide output data, which may include a correction to the code. The defect correction system 204 sends the corrected code to the QA system 206.

In certain aspects, the defect correction system 204 may include multiple AI models 214. The AI models 214 may be or include one or more of: a generative AI model, a transformer model, a generative pre-trained transformer (GPT) model, a machine learning (ML) model, a natural language processing (NLP) model, a deep learning model, a reinforcement learning model, a neural network, a decision tree, logistic regression, linear regression, etc. In some cases, the AI models 214 may have certain performance characteristics. Some of the AI models 214 may have different accuracies (e.g., classification accuracy and/or regression accuracy of the output data), different processing latencies (e.g., the computational time of an AI model), and/or different processing capacities (e.g., capabilities to perform parallel or concurrent processing of data). The defect correction system 204 may select a particular AI model 214 that meets certain performance characteristics or specifications, which may depend on certain settings of the vehicle codebase host.

In certain aspects, the AI models 214 may have certain input/output (I/O) schemes. Some of the AI models 214 may be trained to process certain input data, such as source code in one or more programming languages. For example, a first AI model may be trained to process source code in a first programming language (e.g., Python), whereas a second AI model may be trained to process source code in a second programming language (e.g., C or Rust). In some cases, an AI model may be trained to process the source code in multiple programming languages. In certain cases, an AI model may be trained to transform the source code from one programming language to another programming language. In certain aspects, some of the AI models 214 may be trained to provide certain output data, such as multiple candidate corrections to the defective code, a correction in a specific programming language, a correction that satisfies certain functional safety standards for a vehicle, etc. The defect correction system 204 may select a particular AI model 214 that is capable of processing the source code provided to the defect correction system 204 and/or meeting certain criteria for the corrected code.

In certain aspects, the defect correction system 204 may use multiple AI models in a processing pipeline to generate the corrected code. As an example of a processing pipeline, a first AI model may convert the defective code into a classification of software components or a framework for the corrected code; a second AI model may convert the software components into source code that corrects the defect; and a third AI model may transform the source code into one or more executable packages of the corrected code. In some cases, these various AI models may be integrated into an AI system, such as the defect correction system 204.

The QA system 206 is configured to test the output data of the AI model 214. The QA system 206 may determine whether the corrected code, which was output by the defect correction system 204, satisfies one or more evaluation criteria. The QA system 206 may evaluate the generated candidate fixes using techniques such as static analysis, testing, or code review. By assessing the correctness, efficiency, and maintainability of the generated fixes, the QA system 206 may rank and select the most suitable fixes from the generated candidates. In certain aspects, the evaluation criteria may include a functional safety standard including one or more safety integrity levels. As an example, the functional safety standard may be or include any applicable functional safety standard for vehicles, such as the International Organization for Standardization (ISO) 26262-1:2018 that defines safety standards for safety-related systems that include one or more electrical and/or electronic (E/E) systems installed in a road vehicle or any or any future version of the specification. For example, the evaluation criteria may evaluate whether certain redundancies and/or built-in self-tests are implemented in the corrected code. The evaluation criteria may include performance metrics (or indicators), such as processing latency, memory usage, processor usage, storage size, user satisfaction, etc. The evaluation criteria may include correcting any or all of the defects identified at the defection detection system 202.

In some cases, the QA system 206 may run automated and/or pre-configured tests on the corrected code. Through the testing, the QA system 206 may evaluate whether any or all of the defects are corrected in the code output at the defection correction system 204. In certain aspects, if the QA system 206 identifies that corrected code does not satisfy certain criteria, the QA system 206 may provide a report to the defection correction system 204. The defection correction system 204 may obtain the report and output an updated version of the corrected code based on the report.

The QA system 206 may integrate the selected fixes into the existing codebase and conduct thorough testing and validation. The testing and validation may ensure that the AI-based fixes address the identified defects without introducing new issues or breaking existing functionality. The QA system 206 may further perform regression testing and ensure the overall quality and stability of the codebase.

In certain aspects, the QA system 204 may include one or more AI models 216 (hereinafter “the AI model 216”) that evaluate the performance and/or quality of the corrected code output at the defection correction system 204. As an example, the AI model 216 may provide the report (e.g., a score or prediction) on the updated code corrected correcting the defects and/or satisfying certain criteria, such as the function safety standard and/or performance metrics. The AI model 216 may provide the report to the defection correction system 204, which may update the code based on the report. Note that certain aspects of the AI model 214 may be representative of the AI model 216.

The deployment system 208 is configured to transfer the corrected code to a vehicle, such as the vehicle 112. In certain aspects, the deployment system 208 may store and/or host the corrected code, for example, as described herein with respect to FIG. 1. In certain aspects, the deployment system 208 may send a notification to the vehicle 112 that updated code is available for installation.

In certain aspects, the defect correction system 204 may obtain feedback 218 on the corrected code generated via the AI model 214. As an example, in response to using or reviewing the corrected code, a user of the code may send the feedback 218 to the defect correction system 204. The feedback may indicate whether any or all of the defects have been addressed or resolved in the corrected code. Based on the feedback indicating that one or more defects are present in the corrected code, the defect correction system 204 may output an updated version of the code and send the updated version to the user. The user that provides the feedback 224 may be or include a reviewer of the codebase, a developer of the codebase, and/or an end user of the code, for example.

In certain aspects, the defect detection system 202 may include one or more guardrails that prevent a codebase of certain systems from being updated by the defection correction system 204. For example, the defect detection system 202 may prevent automatic code generation for safety systems (e.g., advanced driver-assistance system (ADAS) or safety systems associated with certain ADAS levels). The defect detection system 202 may be configured with a list of software codebases to refrain from passing defective code to the defection correction system 204, and thus, preventing automatic code generation (e.g., a code generation refrain list), and/or a list of software codebases to perform automatic code generation. For the codebases identified in the code generation refrain list, the defect detection system 202 may provide a warning after detecting the defects in such codes. For example, the defect detection system 202 may provide a notification of the defect to a database for tracking code defects (an issue tracking system), a vendor (that may be responsible for the code), and/or an original equipment manufacturer (OEM) for further inspection.

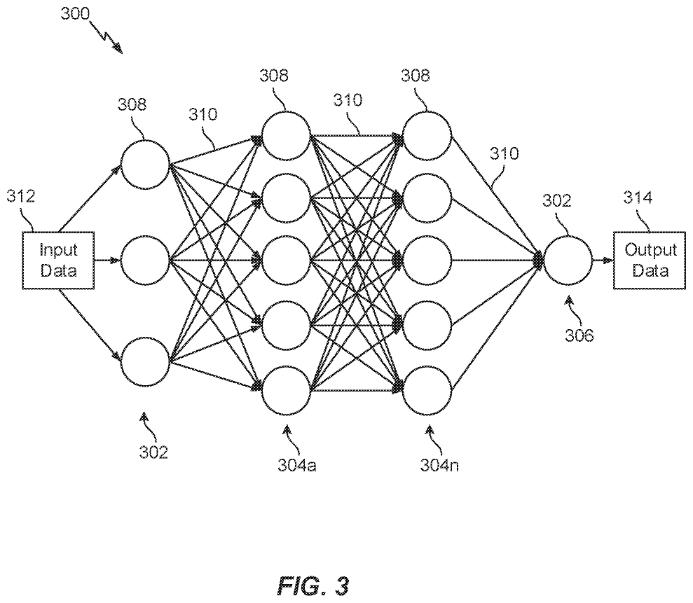

FIG. 3 depicts an example neural network 300 for software application generation. In this example, the neural network 300 may include multiple layers 302, 304a, 304n, 306, having one or more nodes 308 (e.g., artificial neurons or perceptrons), connected by connection paths 310 (e.g., synapses). The neural network 300 includes at least an input layer 302 and an output layer 306. In some cases, the neural network 300 includes one or more hidden layers 304a-304n. The input layer 302 represents input data 312 that is fed into the neural network 300. For example, the input data 312 may include defective code and/or an indication or description of the defect. In some cases, the input data 312 may undergo pre-processing, such as normalization, segmentation, concatenation, etc. The input data 312 may be input into the neural network 300 at the input layer 302. The neural network 300 may process the input data 312 at the input layer 302 through the corresponding nodes 308 and/or connection paths 310. In certain aspects, each of the connection paths 310 may have a corresponding weight (e.g., a synaptic weight) that is applied to the value of a previous node to determine the value of a target node interconnected by the respective connection path 310.

In certain aspects, a node 308 may calculate its current value using synaptic weights of connection paths coupled to the node 308 and the previous layer and the output values of the nodes coupled to the connection paths. In some cases, the node 308 may calculated is current value using a summation of the weighted output values of all incoming connection paths 310 using the respective synaptic weights. In certain aspects, an activation function may be applied to the weighted sum calculated at any of the nodes. The result of the activation function may be the output value of the node. An activation function may be or include a rectifier activation function (e.g., a rectified linear unit (ReLU)), a sigmoid function, a hyperbolic tangent (tanh), for example.

The one or more hidden layers 304a-n, depending on the inputs from the input layer 302 and the weights on the connection paths 310, carry out computational activities. For example, each of the hidden layers 304a-n perform computations and transfer information from the input layer 302 to the output layer 306 through their associated nodes 308 and connection paths 310. The one or more hidden layer(s) 304a-n may feed into one or more nodes 308 of the output layer 306. There may be one or more output layers 306 depending on the configuration of the neural network 300. As an example, the neural network 300 may be trained to generate output data 314 including, for example, code that corrects the defect as described herein with respect to FIG. 2.

In general, when a neural network is learning (or being trained), the neural network is identifying and determining patterns within the input data 312 received at the input layer 302. In response, one or more parameters, for example, weights associated to connection paths 310 between nodes 308, may be adjusted through a process known as back-propagation. Note that there are various processes in which learning may occur, however, two general learning processes include associative mapping and regularity detection. Associative mapping refers to a learning process where a neural network learns to produce a particular pattern on the set of inputs whenever another particular pattern is applied on the set of inputs. Regularity detection refers to a learning process where the neural network learns to respond to particular properties of the input patterns. Whereas in associative mapping the neural network stores the relationships among patterns, in regularity detection the response of each unit has a particular “meaning”. This type of learning mechanism may be used for feature discovery and knowledge representation.

Neural networks possess knowledge that is contained in the values of the synaptic weights. Modifying the knowledge stored in the network as a function of experience implies a learning rule for changing the values of the weights. Information may be stored in a weight matrix W of a neural network. Learning may involve determination and/or adjustment of one or more weights. Following the way learning is performed, two major categories of neural networks can be distinguished: a) fixed networks in which the weights cannot be changed (i.e., dW/dt=0) and a) adaptive networks which are able to change their weights (i.e., dW/dt not=0). In fixed networks, the weights are fixed a priori according to the problem to solve.

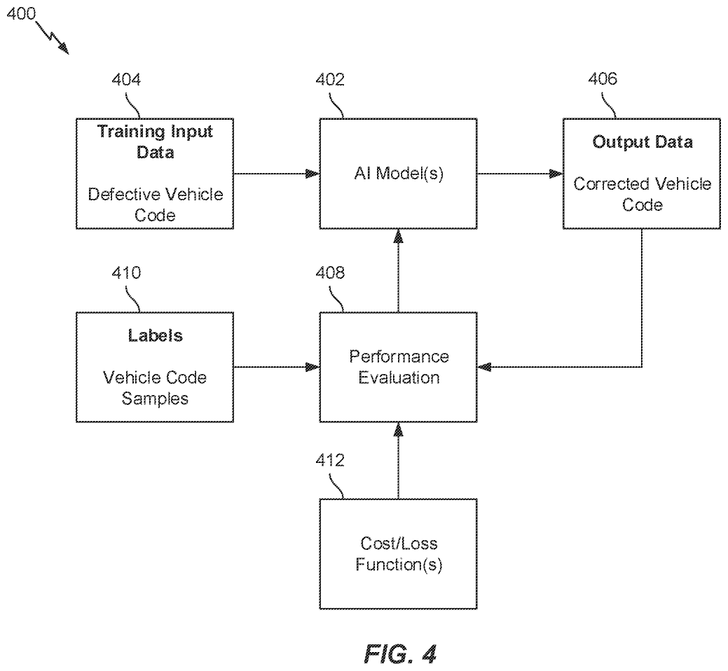

FIG. 4 depicts an example architecture 400 for training one or more AI models 402 (hereinafter “the AI model 402”) to correct defective code. The AI model 402 may be an example of any of the AI models described herein, such as the AI model 214, 212, 244, and/or the neural network 300.

In this example, the AI model 402 obtains training input data 404 and processes the training input data 404 to produce output data 406. The training input data 404 may include samples of defective code, such as code with typos, undeclared variables, memory leaks, inefficient performance, bugs, etc. At 408, an AI host (e.g., the vehicle codebase host 102) may evaluate the performance of the output data 406 and adjust the AI model 402 based on the respective performance. In some cases, the AI host may compare the output data 406 to one or more labels 410 corresponding to the training input data 404. The labels 410 may include the expected output of the AI model 402 for the training input data 404. As an example, the labels 410 may include corrected code samples that correspond to the defective code samples. In certain aspects, the labels 410 may include code samples associated with software and/or firmware that satisfies certain criteria, such as functional safety standards and/or performance metrics for embedded computing systems of one or more vehicles. In certain aspects, the labels 410 may include the expected performance metrics or outcomes of the corrected code samples. In certain aspects, the labels 410 may include one or more vehicle-specific code samples, such as software and/or firmware that is configured to perform certain vehicle actions, controls, and/or functions including, for example, ADAS, drivetrain, powertrain, braking, transmission, emissions, signaling, navigation, infotainment, etc. The vehicle-specific code samples may be configured to be efficient in terms of memory usage, processor usage, processing latency in order to execute the vehicle actions or controls, for example, in real time and/or satisfy a functional safety standard.

The AI host may compare the output data 406 to the labels 410 using one or more loss or cost functions 412 (hereinafter “the cost function 412”). The cost function 412 may calculate or determine a difference between the output data and the corresponding label. For example, the cost function 412 may determine a difference or error (e.g., a mean squared error) between certain performance metrics of the corrected code and the expected output.

As an example, in order to train a neural network (e.g., the neural network 300) to perform some task (e.g., generate an executable package), adjustments to the weights of the connection paths are made in such a way that an error (e.g., a cost or a loss) between the desired or expected output (e.g., the labels 410) and the actual output (e.g., the output data 406) is reduced. The error may be determined according to the cost function 412. This process may involve the neural network computing the error derivative of the weights (EW). In other words, the neural network may calculate how the error changes as each weight is increased or decreased. A back-propagation algorithm is one method that is used for determining the EW.

The algorithm computes each EW by first computing the error derivative (EA), the rate at which the error changes as the activity level of a unit is changed. For output units, the EA is simply the difference between the actual and the desired output. To compute the EA for a hidden unit in the layer just before the output layer, first all the weights between that hidden unit and the output units to which it is connected are identified. Then, those weights are multiplied by the EAs of those output units and the products are added. This sum equals the EA for the chosen hidden unit. After calculating all the EAs in the hidden layer just before the output layer, in like fashion, the EAs for other layers may be computed, moving from layer to layer in a direction opposite to the way activities propagate through the neural network, hence “back propagation”. Once the EA has been computed for a unit, it is straight forward to compute the EW for each incoming connection of the unit. The EW is the product of the EA and the activity through the incoming connection. Note that this is only one method in which a neural network is trained to perform a task. In certain aspects, the AI model 402 may be trained using supervised learning and/or reinforcement learning. The AI model 402 may be trained via online training or via batched training methods.

### Example AI-based Vehicle Software Management Operations

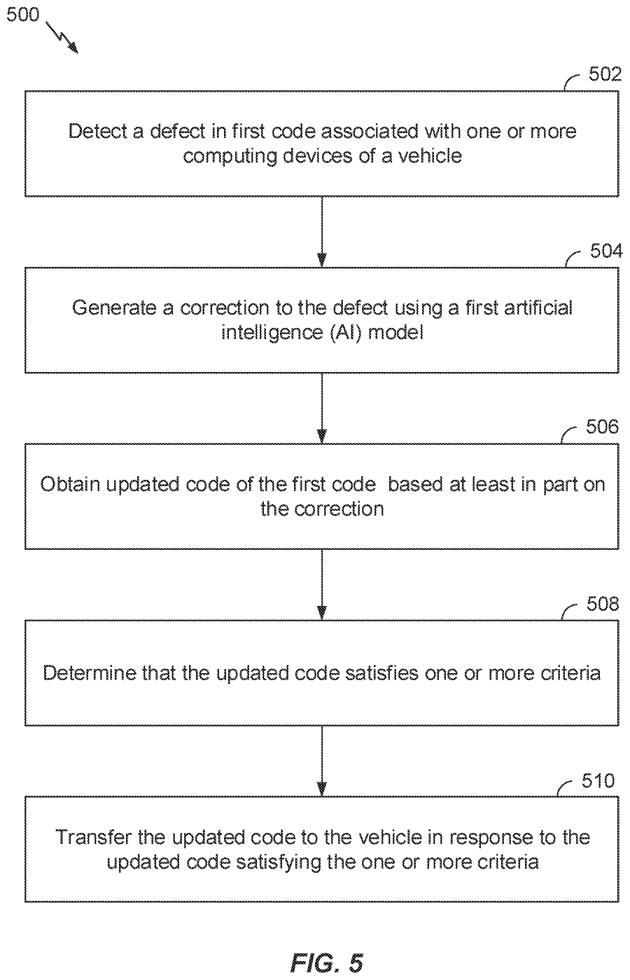

FIG. 5 depicts example operations 500 of AI-based vehicle software management. The operations 500 may be performed by a processing system, such as the vehicle codebase host 102.

The operations 500 may optionally begin at block 502, where the processing system detects a defect in first code (e.g., software and/or firmware) associated with one or more computing devices (e.g., the computing devices 120) of a vehicle (e.g., the vehicle 112). In some cases, to detect the defect, the processing system may obtain a notification of the defect from one or more sources including an issue tracking system, a log of the vehicle, a report of the vehicle, or a combination thereof. In certain aspects, the one or more computing devices comprises one or more processors (e.g., the processor 134). In certain aspects, the first code comprises one or more instructions that, when executed by the one or more processors, cause the vehicle to perform one or more actions (e.g., vehicle-specific actions or functions). In certain aspects, the defect comprises an error in the first code that, when executed by the one or more processors, causes the one or more processors to produce an incorrect or unexpected result.

At block 504, the processing system generates a correction to the defect using a first AI model (e.g., the AI model 110, 214 and/or neural network 300). To generate the correction, the processing system may provide, to the first AI model, input data comprising an indication of the defect in the first code; and the processing system may obtain, from the first AI model, output data comprising an indication of the correction. In certain aspects, the one or more computational devices comprises one or more microcontroller units (MCUs); one or more electronic control units (ECUs); one or more sensors; one or more advanced driver-assistance systems (ADAS); a data communications module; or any combination thereof.

At block 506, the processing system obtains updated code of the first code based at least in part on the correction. As an example, the processing system may merge or integrate the correction with a codebase including the first code or source code thereof. In certain aspects, the updated code may include processor-executable instructions such as object code.

At block 508, the processing system determines that the updated code satisfies one or more criteria. In certain aspects, the one or more criteria comprises a functional safety standard (e.g., ISO 26262:2018) including one or more safety integrity levels (e.g., automotive safety integrity levels (ASILs)); one or more performance indicators (e.g., processing latency, memory usage, processor usage, storage size, user satisfaction, etc.); or a combination thereof.

At block 510, the processing system transfers the updated code to the vehicle in response to the updated code satisfying the one or more criteria. For example, the processing system may send the updated to the vehicle via a data network or communications interface.

In certain aspects, the processing system may detect the defect using an AI model (e.g., the AI model 212). For example, to detect the defect, the processing system may provide, to a second AI model, input data comprising the first code; and the processing system may obtain, from the second AI model, output data comprising an indication of the defect.

In certain aspects, the processing system may perform model training on the first AI model. For example, the processing system may train the first AI model to correct defective code of the vehicle using training code as expected output, where the training code is configured to perform one or more vehicle functions, for example, as discussed above with respect to FIG. 4. In certain aspects, the processing system may evaluate output data of the first AI model based at least in part on the training code; and the processing system may adjust the first AI model based at least in part on the evaluated output data, where the one or more vehicle functions satisfy a functional safety standard.

In certain aspects, the processing system may apply one or more guardrails to avoid updating certain code, such as code implementing an ADAS function at a particular ADAS level and/or ASIL. The processing system may detect at least one defect in second code associated with the one or more computing devices of the vehicle; and the processing system may send a notification of the at least one defect in response to identifying that the second code is prohibited from defect correction using the first AI model.

### Example Vehicle Software Management Host

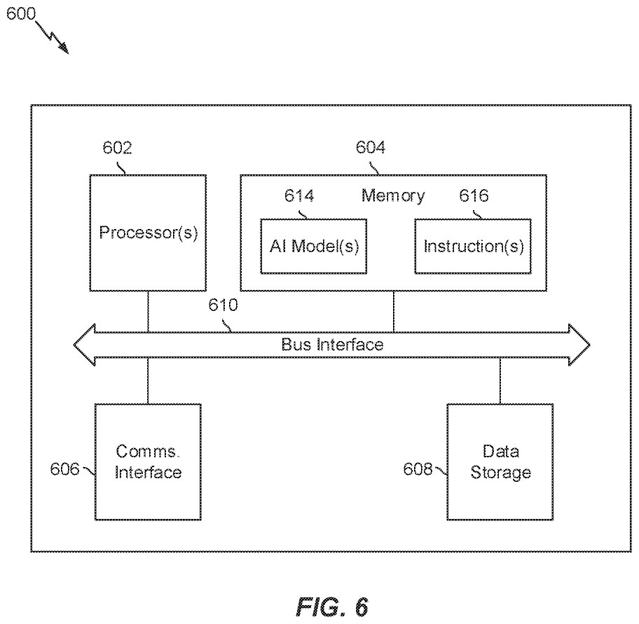

FIG. 6 depicts an example of a processing system 600 that is configured to perform the operations described herein. In some aspects, the processing system 600 is an example of or includes the vehicle codebase host 102 of FIG. 1. One or more of the functionalities and/or components associated with AI-based vehicle software management described herein may be provided by the processing system 600.

As shown, the processing system 600 includes one or more processors 602 (hereinafter “the processor 602”), one or more memories 604 (hereinafter “the memory 604”), a communications interface 606, a data storage component 608, and a bus interface 610. The bus interface 610 may facilitate communication among the components of the processing system 600.

The memory 604 may be configured as volatile and/or nonvolatile memory and as such, may include random access memory (including static RAM (SRAM), dynamic RAM (DRAM), and/or other types of RAM), flash memory, ROM, secure digital (SD) memory, registers, compact discs (CD), digital versatile discs (DVD) (whether local or cloud-based), and/or other types of non-transitory processor-readable medium. The memory 604 may reside within the processing system 600 and/or a device that is external to the processing system 600.

The memory 604 may store one or more AI model(s) 614 and processor-executable instructions 616, each of which may be embodied as a computer program, firmware, and so forth. The AI models 614 may include the AI models described herein with respect to AI-based vehicle software management operations, such as the defect detection system, defect correction system, quality assurance system, and/or any of the underlying models thereof. The processor 602 may access the AI models 614 and the instructions 616 stored on the memory 604. The instructions 616 may include logic or algorithm(s) that execute the AI-based vehicle software management operations described herein. In certain aspects, the instructions 616 may include logic or algorithm(s) implemented via a field-programmable gate array (FPGA) configuration, an application-specific integrated circuit (ASIC), or equivalents. Accordingly, the operations described herein may be implemented in any computer programming language, as programmed hardware elements (e.g., programmable logic), or as a combination of hardware and software components. The processor 602 along with the memory 604 may operate as a controller for the processing system 600. In some cases, the instructions 616 may include an operating system and/or other software for managing components of the processing system 600.

The processor 602 may include any processing component operable to obtain and execute the AI models 614 and/or the instructions 616 from a processor-readable medium (such as the data storage component 608 and/or the memory 604). Accordingly, the processor 602 may be or include one or more of: a microcontroller, a microprocessor, an AI processor, a digital signal processor (DSP), a graphics processing unit (GPU), an FPGA, an ASIC, a system on chip (SoC), a system in package (SiP), an integrated circuit, a microchip, a computer, or any other computing device.

The communications interface 606 may be configured to communicate with other devices. In some cases, the communications interface 606 may include a network interface or a wireless communication interface (e.g., an RF transceiver) used to communicate with other devices, for example, in a data network. In certain cases, the communication interface 606 may be or include an input/output interface for communicating with auxiliary hardware.

In addition to the examples described above, many examples of specific combinations are within the scope of the disclosure, some of which are detailed below:

Aspect 1: A method, comprising: detecting a defect in first code associated with one or more computing devices of a vehicle; generating a correction to the defect using a first artificial intelligence (AI) model; obtaining updated code of the first code based at least in part on the correction; determining that the updated code satisfies one or more criteria; and transferring the updated code to the vehicle in response to the updated code satisfying the one or more criteria.

Aspect 2: The method of Aspect 1, wherein: the one or more computing devices comprises one or more processors; the first code comprises one or more instructions that, when executed by the one or more processors, cause the vehicle to perform one or more actions; and the defect comprises an error in the first code that, when executed by the one or more processors, causes the one or more processors to produce an incorrect or unexpected result.

Aspect 3: The method of Aspect 1 or 2, wherein detecting the defect comprises obtaining a notification of the defect from one or more sources including an issue tracking system, a log of the vehicle, a report of the vehicle, or a combination thereof.

Aspect 4: The method according to any of Aspects 1-3, wherein detecting the defect comprises: providing, to a second artificial intelligence (AI) model, input data comprising the first code; and obtaining, from the second AI model, output data comprising an indication of the defect.

Aspect 5: The method according to any of Aspects 1-4, further comprises training the first AI model to correct defective code of the vehicle using training code as expected output, wherein the training code is configured to perform one or more vehicle functions.

Aspect 6: The method of Aspect 5, wherein training the first AI model comprises: evaluating output data of the first AI model based at least in part on the training code; and adjusting the first AI model based at least in part on the evaluated output data, wherein the one or more vehicle functions satisfy a functional safety standard.

Aspect 7: The method according to any of Aspects 1-6, wherein generating the correction comprises: providing, to the first AI model, input data comprising an indication of the defect in the first code; and obtaining, from the first AI model, output data comprising an indication of the correction.

Aspect 8: The method according to any of Aspects 1-7, wherein the one or more criteria comprises: a functional safety standard including one or more safety integrity levels; one or more performance indicators; or a combination thereof.

Aspect 9: The method according to any of Aspects 1-8, further comprising: detecting at least one defect in second code associated with the one or more computing devices of the vehicle; and sending a notification of the at least one defect in response to identifying that the second code is prohibited from defect correction using the first AI model.

Aspect 10: The method according to any of Aspects 1-9, wherein the one or more computational devices comprises: one or more microcontroller units (MCUs); one or more electronic control units (ECUs); one or more sensors; one or more advanced driver-assistance systems (ADAS); a data communications module; or any combination thereof.

Aspect 11: A system, comprising: one or more memories; and one or more processors coupled to the one or more memories, the one or more processors being configured to cause the system to: detect a defect in first code associated with one or more computing devices of a vehicle; generate a correction to the defect using a first artificial intelligence (AI) model; obtain updated code of the first code based at least in part on the correction; determine that the updated code satisfies one or more criteria; and transfer the updated code to the vehicle in response to the updated code satisfying the one or more criteria.

Aspect 12: The system of Aspect 11, wherein: the one or more computing devices comprises at least one processor; the first code comprises one or more instructions that, when executed by the at least one processor, cause the vehicle to perform one or more actions; and the defect comprises an error in the first code that, when executed by the at least one processor, causes the at least one processor to produce an incorrect or unexpected result.

Aspect 13: The system of Aspect 11 or 12, wherein to detect the defect, the one or more processors are configured to cause the system to obtain a notification of the defect from one or more sources including an issue tracking system, a log of the vehicle, a report of the vehicle, or a combination thereof.

Aspect 14: The system according to any of Aspects 11-13, wherein to detect the defect, the one or more processors are configured to cause the system to provide, to a second artificial intelligence (AI) model, input data comprising the first code; and obtain, from the second AI model, output data comprising an indication of the defect.

Aspect 15: The system according to any of Aspects 11-14, wherein the one or more processors are configured to cause the system to train the first AI model to correct defective code of the vehicle using training code as expected output, wherein the training code is configured to perform one or more vehicle functions.

Aspect 16: The system of Aspect 15, wherein to train the first AI model, the one or more processors are configured to cause the system to: evaluate output data of the first AI model based at least in part on the training code; and adjust the first AI model based at least in part on the evaluated output data, wherein the one or more vehicle functions satisfy a functional safety standard.

Aspect 17: The system according to any of Aspects 11-16, wherein to generate the correction, the one or more processors are configured to cause the system to: provide, to the first AI model, input data comprising an indication of the defect in the first code; and obtain, from the first AI model, output data comprising an indication of the correction.

Aspect 18: The system according to any of Aspects 11-17, wherein the one or more criteria comprises: a functional safety standard including one or more safety integrity levels; one or more performance indicators; or a combination thereof.

Aspect 19: The system according to any of Aspects 11-18, wherein the one or more processors are configured to cause the system to: detect at least one defect in second code associated with the one or more computing devices of the vehicle; and send a notification of the at least one defect in response to identifying that the second code is prohibited from defect correction using the first AI model.

Aspect 20: The system according to any of Aspects 11-19, wherein the one or more computational devices comprises: one or more microcontroller units (MCUs); one or more electronic control units (ECUs); one or more sensors; one or more advanced driver-assistance systems (ADAS); a data communications module; or any combination thereof.

Aspect 21: A system, comprising: means for detecting a defect in first code associated with one or more computing devices of a vehicle; means for generating a correction to the defect using a first artificial intelligence (AI) model; means for obtaining updated code of the first code based at least in part on the correction; means for determining that the updated code satisfies one or more criteria; and means for transferring the updated code to the vehicle in response to the updated code satisfying the one or more criteria.

Aspect 22: A non-transitory computer-readable medium having instructions stored thereon for: detecting a defect in first code associated with one or more computing devices of a vehicle; generating a correction to the defect using a first artificial intelligence (AI) model; obtaining updated code of the first code based at least in part on the correction; determining that the updated code satisfies one or more criteria; and transferring the updated code to the vehicle in response to the updated code satisfying the one or more criteria.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method, comprising:
detecting a defect in first code associated with one or more computing devices of a vehicle;
generating a correction to the defect using a first artificial intelligence (AI) model;
obtaining updated code of the first code based at least in part on the correction;
determining that the updated code satisfies one or more criteria; and
transferring the updated code to the vehicle in response to the updated code satisfying the one or more criteria.

2. The method of claim 1, wherein:
the one or more computing devices comprises one or more processors;
the first code comprises one or more instructions that, when executed by the one or more processors, cause the vehicle to perform one or more actions; and
the defect comprises an error in the first code that, when executed by the one or more processors, causes the one or more processors to produce an incorrect or unexpected result.

3. The method of claim 1, wherein detecting the defect comprises obtaining a notification of the defect from one or more sources including an issue tracking system, a log of the vehicle, a report of the vehicle, or a combination thereof.

4. The method of claim 1, wherein detecting the defect comprises:
providing, to a second artificial intelligence (AI) model, input data comprising the first code; and
obtaining, from the second AI model, output data comprising an indication of the defect.

5. The method of claim 1, further comprises training the first AI model to correct defective code of the vehicle using training code as expected output, wherein the training code is configured to perform one or more vehicle functions.

6. The method of claim 5, wherein training the first AI model comprises:
evaluating output data of the first AI model based at least in part on the training code; and
adjusting the first AI model based at least in part on the evaluated output data, wherein the one or more vehicle functions satisfy a functional safety standard.

7. The method of claim 1, wherein generating the correction comprises:
providing, to the first AI model, input data comprising an indication of the defect in the first code; and
obtaining, from the first AI model, output data comprising an indication of the correction.

8. The method of claim 1, wherein the one or more criteria comprises:
a functional safety standard including one or more safety integrity levels;
one or more performance indicators; or
a combination thereof.

9. The method of claim 1, further comprising:
detecting at least one defect in second code associated with the one or more computing devices of the vehicle; and
sending a notification of the at least one defect in response to identifying that the second code is prohibited from defect correction using the first AI model.

10. The method of claim 1, wherein the one or more computational devices comprises:
one or more microcontroller units (MCUs);
one or more electronic control units (ECUs);
one or more sensors;
one or more advanced driver-assistance systems (ADAS);
a data communications module; or
any combination thereof.

11. A system, comprising:
one or more memories; and
one or more processors coupled to the one or more memories, the one or more processors being configured to cause the system to:
detect a defect in first code associated with one or more computing devices of a vehicle;
generate a correction to the defect using a first artificial intelligence (AI) model;
obtain updated code of the first code based at least in part on the correction;
determine that the updated code satisfies one or more criteria; and
transfer the updated code to the vehicle in response to the updated code satisfying the one or more criteria.

12. The system of claim 11, wherein:
the one or more computing devices comprises at least one processor;
the first code comprises one or more instructions that, when executed by the at least one processor, cause the vehicle to perform one or more actions; and
the defect comprises an error in the first code that, when executed by the at least one processor, causes the at least one processor to produce an incorrect or unexpected result.

13. The system of claim 11, wherein to detect the defect, the one or more processors are configured to cause the system to obtain a notification of the defect from one or more sources including an issue tracking system, a log of the vehicle, a report of the vehicle, or a combination thereof.

14. The system of claim 11, wherein to detect the defect, the one or more processors are configured to cause the system to
provide, to a second artificial intelligence (AI) model, input data comprising the first code; and
obtain, from the second AI model, output data comprising an indication of the defect.

15. The system of claim 11, wherein the one or more processors are configured to cause the system to train the first AI model to correct defective code of the vehicle using training code as expected output, wherein the training code is configured to perform one or more vehicle functions.

16. The system of claim 15, wherein to train the first AI model, the one or more processors are configured to cause the system to:
evaluate output data of the first AI model based at least in part on the training code; and
adjust the first AI model based at least in part on the evaluated output data, wherein the one or more vehicle functions satisfy a functional safety standard.

17. The system of claim 11, wherein to generate the correction, the one or more processors are configured to cause the system to:
provide, to the first AI model, input data comprising an indication of the defect in the first code; and
obtain, from the first AI model, output data comprising an indication of the correction.

18. The system of claim 11, wherein the one or more criteria comprises:
a functional safety standard including one or more safety integrity levels;
one or more performance indicators; or
a combination thereof.

19. The system of claim 11, wherein the one or more processors are configured to cause the system to:
detect at least one defect in second code associated with the one or more computing devices of the vehicle; and
send a notification of the at least one defect in response to identifying that the second code is prohibited from defect correction using the first AI model.

20. The system of claim 11, wherein the one or more computational devices comprises:
one or more microcontroller units (MCUs);
one or more electronic control units (ECUs);
one or more sensors;
one or more advanced driver-assistance systems (ADAS);
a data communications module; or
any combination thereof.
